(19) United States
(12) Patent Application Publication
(10) Pub. No.: US 2008/0059433 A1
(43) Pub. Date: Mar. 6, 2008

(54) SYSTEM AND METHOD FOR COMMUNICATING BETWEEN GRAPHICAL USER INTERFACES

(75) Inventors: Jim Callan, Dublin (IE); Stephen Ryan, Galway (IE)

Correspondence Address: OSLER, HOSKIN & HARCOURT, LLP (OTHER), 1000 DE LA GAUCHETIERE STREET WEST, SUITE 2100, MONTREAL, QC, H3B-4W5, US

(73) Assignee: ECONIQ LTD., Galway (IE)

(21) Appl. No.: 11/847,832

(22) Filed: Aug. 30, 2007

(30) Foreign Application Priority Data
Aug. 30, 2006 (IE) 2006/0644

(51) Int. Cl. G06F 17/30

(52) U.S. Cl. 707/3; 707/E17.005

(57) ABSTRACT

The invention relates to a method of communicating between graphical user interfaces by monitoring events of a first graphical user interface and by updating a second graphical user interface with respect to the monitored events of the first graphical user interface. It comprises monitoring events of the first graphical user interface; querying a database of events by comparing a monitored event of the first graphical user interface with events stored in the database of events; and updating the second graphical user interface should the monitored event of the first graphical user interface match one of the events stored in the database of events. A system for communicating between a first and a second graphical user interfaces, as well as a machine readable program storage medium, embodying a program to perform a method of communicating between a first and a second graphical user interfaces are also disclosed.

### COPYRIGHT NOTICE

Contained herein is material that is subject to copyright protection. The copyright owner has no objection to the facsimile reproduction of the patent disclosure by any person as it appears in the Patent and Trademark office patent files or records, but otherwise reserves all rights to the copyright whatsoever.

### CROSS-REFERENCE

The present application claims priority to Irish Provisional Patent Application No. 2006/0644 filed on Aug. 30, 2006, the entirety of which is incorporated herein by reference.

### FIELD OF THE INVENTION

The present invention relates to graphical user interfaces, and more particularly to communication between graphical user interfaces.

### BACKGROUND OF THE INVENTION

People using computer systems today typically interact with a graphical user interface (GUI) to make the computer system perform a function. Companies and individuals often develop separate extensions to add new functionality to existing GUI applications. These extensions can automatically plug-in to these GUI applications provided they already support such plug-in behaviour. Products like Microsoft Visual Studio™, Eclipse™, NetBeans™ and Firefox™ all provide plug-in architectures for third-parties to develop separate plug-in components to these GUI applications.

However, there are many other GUI applications that exist today where no such plug-in mechanism exists and the only method of adding new functionality to these GUI applications is by re-engineering their source code and by adding the new functionality directly to that code. This process can be difficult, time-consuming and expensive.

Therefore, there is a need for a system and method for communicating between graphical user interfaces that address at least some of the inconvenient described above.

### SUMMARY OF THE INVENTION

It is an object of the present invention to provide a method of communicating between graphical user interfaces by monitoring events of a first graphical user interface and by updating a second graphical user interface with respect to the monitored events of the first graphical user interface.

It is also an object of the present invention to provide a database of events used to determine if the second graphical user interface is to be updated.

It is an aspect of the present invention to provide a method of communicating between a first graphical user interface and a second graphical user interface. The method comprises monitoring events of the first graphical user interface; querying a database of events by comparing a monitored event of the first graphical user interface with events stored in the database of events; and updating the second graphical user interface should the monitored event of the first graphical user interface match one of the events stored in the database of events.

In a further aspect, the method comprises extracting data from the first graphical user interface; and populating the second graphical user interface with at least a portion of the data extracted from the first graphical user interface should the monitored event of the first graphical user interface match one of the events stored in the database of events.

In an additional aspect, the method comprises using the database of events to indicate data to be extracted from the first graphical user interface should the monitored event of the first graphical user interface match one of the events stored in the database of events. In a further embodiment of the invention the data is text and the monitored event is converted in a markup language. The method further comprises using the text extracted from the first graphical user interface to verify if a match between the monitored event of the first graphical user interface and the one of the events stored in the database of events is correct. Additionally, the method comprises extracting text from the first graphical user interface by maintaining a position from which the text is extracted in a linked positional list and wherein populating the second graphical user interface comprises using the linked positional list. Furthermore, in an additional embodiment, the second graphical user interface is at least partially wrapped around the first graphical user interface.

In a further aspect, the method comprises monitoring events of a third graphical user interface; querying a database of events by comparing a monitored event of the third graphical user interface with events stored in the database of events; and updating the second graphical user interface should the monitored event of the third graphical user interface match one of the events stored in the database of events.

In another aspect, the invention provides a system for communicating between a first graphical user interface and a second graphical user interface. The system comprises a first monitoring component monitoring events of the first graphical user interface; a database of events, the first monitoring component querying the database of events to determine if a monitored event of the first graphical user interface matches one of the events stored in the database of events; and a second monitoring component detecting that an update of the second graphical user interface is necessary should the monitored event of the first graphical user interface match one of the events stored in the database of events.

In another aspect, the invention provides a machine readable program storage medium, embodying a program of instructions executable by a machine to perform a method of communicating between a first graphical user interface and a second graphical user interface. The machine readable program storage medium comprises instructions for monitoring events of the first graphical user interface; querying a database of events by comparing a monitored event of the first graphical user interface with events stored in the database of events; and updating the second graphical user interface should the monitored event of the first graphical user interface match one of the events stored in the database of events.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of the embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 depicts a screen shot of a graphical user interface;

FIG. 2 depicts screen shots showing results of user interaction;

FIG. 3 depicts a screen shot of the graphical user interface of FIG. 1, showing additional functionality by wrapping around displays;

FIG. 4 depicts a screen shot of the additional functionality of FIG. 3;

FIG. 5 depicts a set of shapes that can be taken by the additional functionality;

FIG. 6 depicts another set of shapes that can be taken by the additional functionality;

FIG. 7 depicts another shape that can be taken by the additional functionality;

FIG. 8 depicts a flowchart of a method of communicating between graphical user interfaces;

FIG. 9 depicts a flowchart of a method of identifying an event;

FIG. 10 depicts a screen shot of another graphical user interface;

FIG. 11 depicts a screen shot of another graphical user interface;

FIG. 12 depicts a system for communicating between graphical user interfaces; and

FIG. 13 depicts an example of a computer system capable of carrying out a method of communicating between graphical user interfaces.

### DETAILED DESCRIPTION OF THE PREFERRED EMBODIMENTS

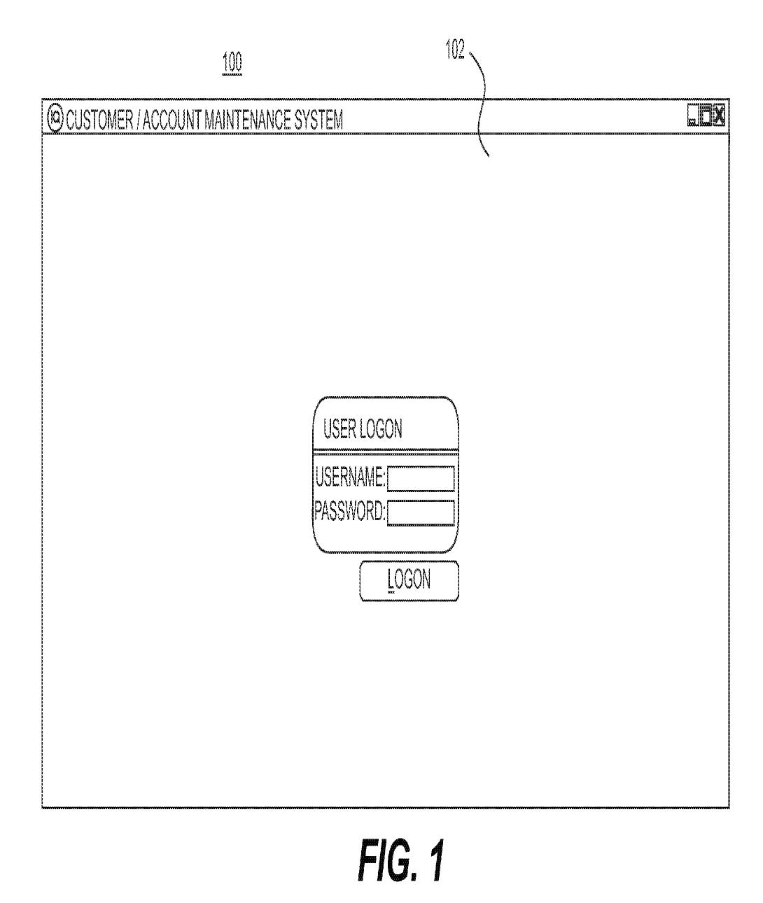

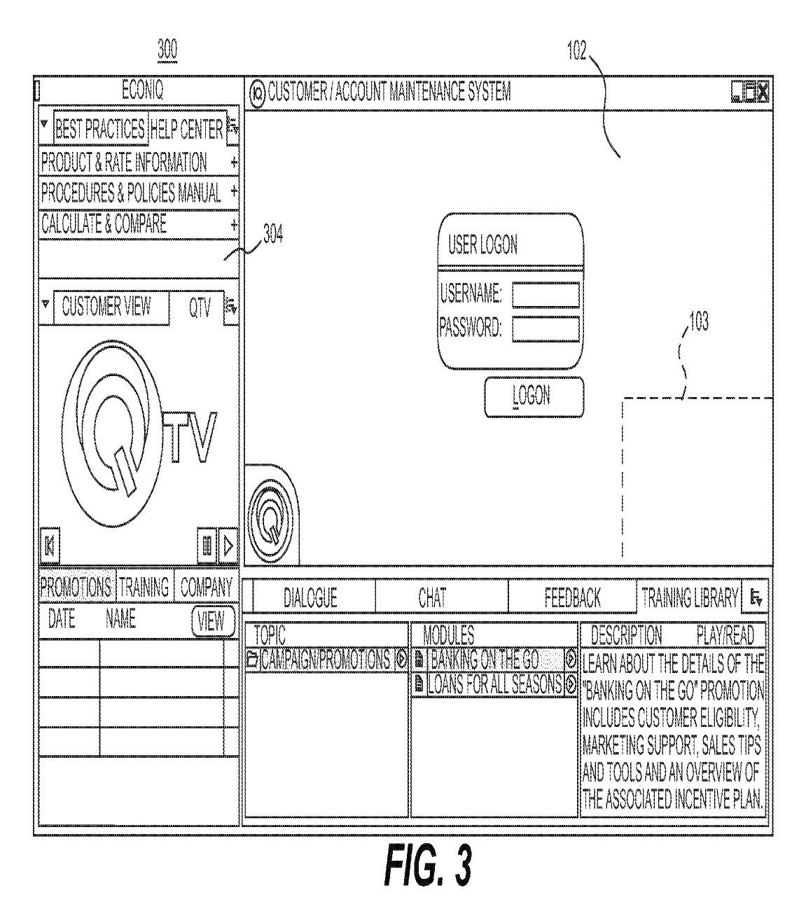

A parent graphical user interface (or GUI) is integrated with one or more separate child graphical user interfaces. For example, a parent GUI 304 of FIG. 3 and child GUI 102 of FIG. 1 can be connected together through any freely accessible event system of the child GUI 102 that the parent GUI 304 can dynamically hook into. The system discretely monitors the freely accessible events generated by the child GUI 102 and converts them into actions that the parent GUI 304 can react and respond to. Therefore, the system can react to the child GUI 102 application without the requirement to alter or modify the child GUI 102 in any way. The system makes it possible for the parent GUI 304 to react to actions or transitions in the child GUI 102 without any hard-coded or pre-embedded connections between the separate GUI applications.

This may be achieved without adding new functionality as a plug-in and without re-engineering the source code of that GUI application to add the new functionality. However, the system may also be implemented by adding new functionality as a plug-in or re-engineering the source code of that GUI application. The method is also cross-platform as it will work for any native Windows™, Java™ or HTML based GUI applications. In principle, it will work for any GUI application that generates any discretely accessible event or transition.

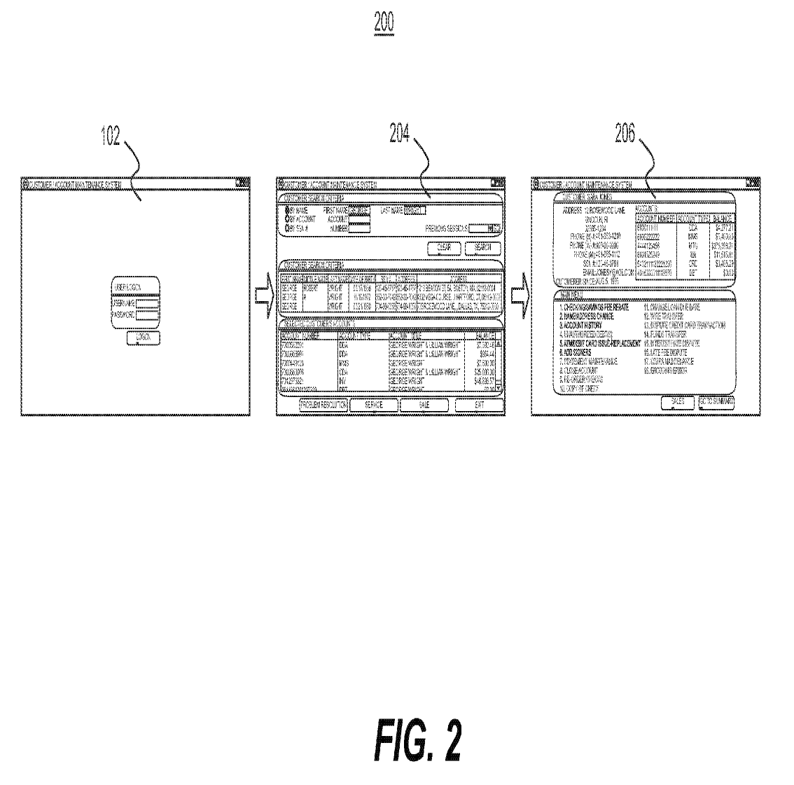

As a user interacts with a GUI application, the GUI application responds to these events by displaying new information on the GUI or by transitioning to a new screen. FIG. 2 shows a series of screens 102, 204 and 206 that is displayed by the GUI application as a user interacts with the GUI application 102 previously shown in FIG. 1. New functionality is added to an existing GUI application by discretely hooking into these GUI events and screen transitions. The system hooks into any freely accessible event or transition system of the child GUI 102. This new functionality is displayed in a separate window alongside the GUI application 102. The new functionality is directly related to what is actually going on in the GUI application 102. FIG. 3 shows an example of new functionality being added to the GUI by wrapping a new or parent GUI (the IQ-GUI) 304 around the existing GUI application 102. Where the screen size of the child GUI 102 is an issue and where it can't be altered in order to fit the IQ-GUI 304 around it, then the IQ-GUI 304 will be made to hover over the child GUI 102, so as not to effect or alter the child GUI 102 size in any way. The parent IQ-GUI 304 reacts to GUI events and screen transitions as if the IQ-GUI 304 application was actually part of the child GUI 102 application but without any physical or real connection between the two applications.

Additionally, it is contemplated that more than one child GUI can be monitored by the same instance of the system. Referring back to FIG. 3, the system hooks into the child GUI 102 and a second child GUI 103 in order to make the IQ-GUI 304 respond to the events and transitions of both the child GUI 102 and the second child GUI 103. It should be appreciated that the child GUI and the second child GUI 103 can be written and built using completely different technologies and architectures. Therefore, the system can be used to wrap and monitor a native windows application, a Java application and a HTML application all using a single instance of the system.

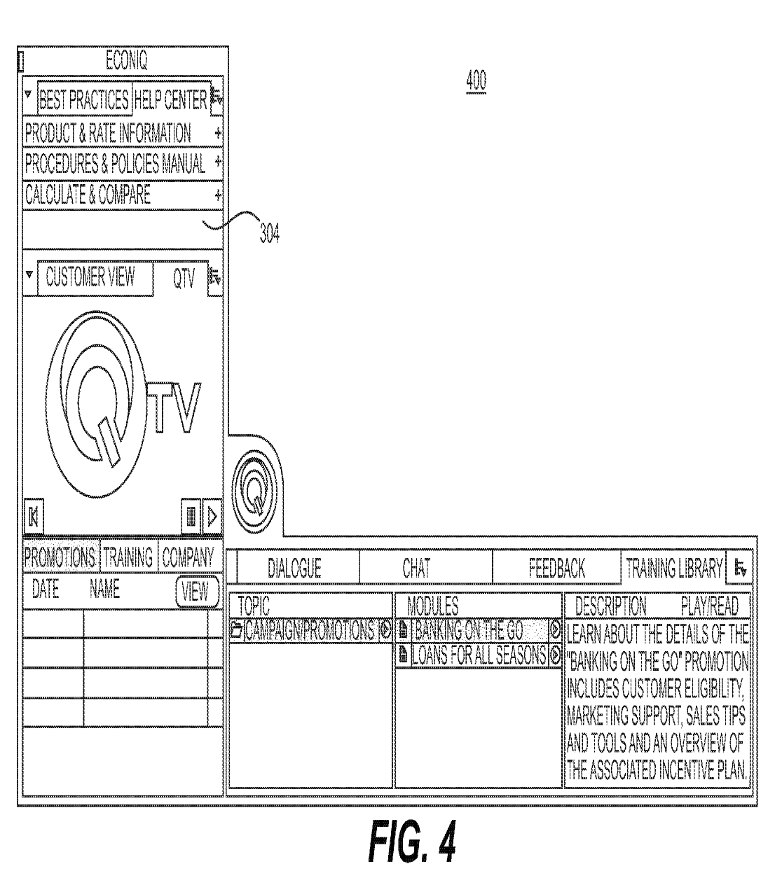

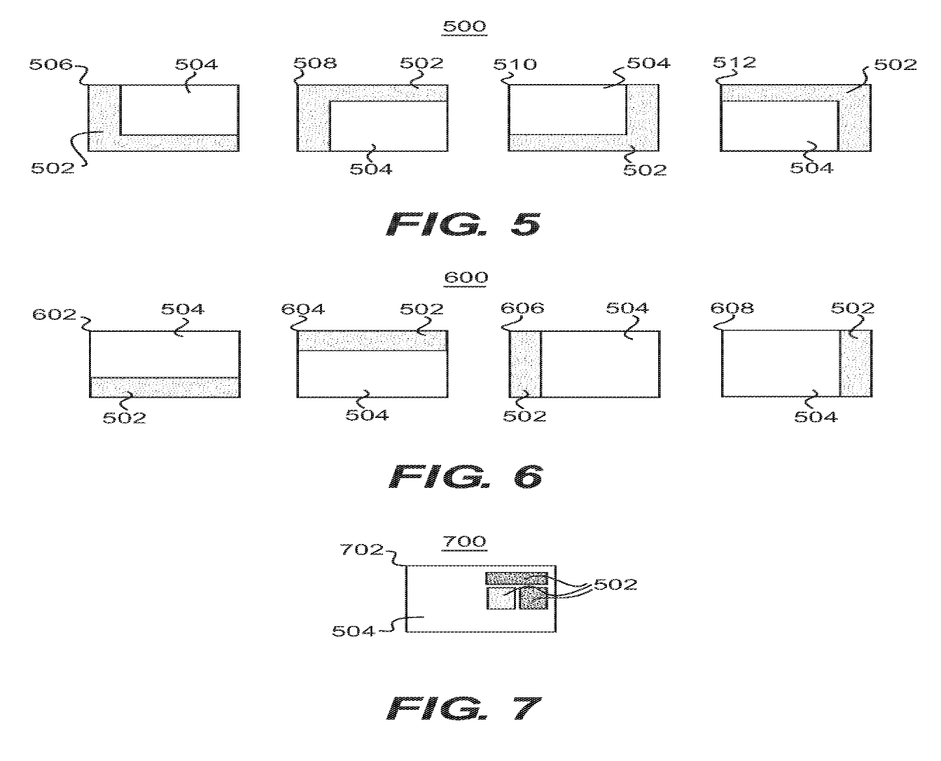

The system runs the GUI application as a separate window or child window 102 of the parent IQ-GUI 304 application. The IQ-GUI 304 application as shown in FIG. 4 can take various shapes as outlined in FIGS. 5-7. As a first example, FIG. 5 depicts various configurations 506, 508, 510 and 512 wherein the shape and position of a parent IQ-GUI 502 vary and lend to wrapping, at least partially, around a child GUI 504. As a second example, FIG. 6 depicts various configurations 602, 604, 606 and 608 wherein the shape and position of a parent IQ-GUI 502 vary and lend to wrapping, at least on a side of a child GUI 504. As a third example, FIG. 7 depicts a configuration 702 wherein a parent IQ-GUI 502 is divided in different floating-over components that lend to wrapping, at least over a portion of a child GUI 504. It should be understood that the configurations mentioned above are not limitative and that other configurations could be used without departing from the scope of the invention.

The IQ-GUI 304 application provides various components that are used to display and provide new functionality that the child GUI 102 application does not provide. The system, referred hereinafter as IQ-Connect, discretely hooks into the child GUI 102 event or transition system and forces the IQ-GUI 304 to react and display based on how the IQ-Connect system interprets that child's GUI 102 event or transition.

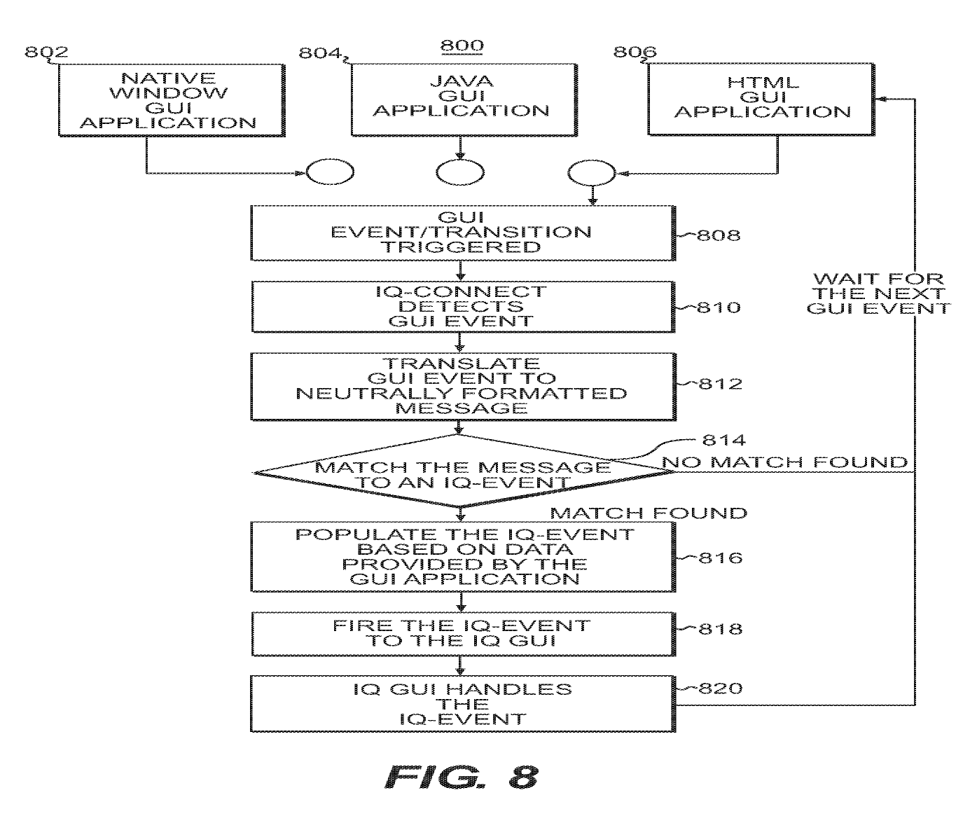

Reference is now made to FIG. 8, where the high level steps of a method 800 that IQ-Connect implements in converting a child GUI 102 event or transition to making the IQ-GUI 304 respond. The method 800 starts at step 808 where the user triggers a child GUI 102 event or transition and where IQ-Connect hooks into the child GUI's 102 event and transition system. Typically the event queue for GUI applications 802 or 804 or a navigation listener in a HTML application 806. At step 810, an IQ-Connect event/transition listener detects that an event has occurred in the child GUI 102. Next, at step 812, IQ-Connect translates the child GUI 102 event to a neutral format. The step 812 allows the IQ-Connect to be used as a cross-platform system since the child GUI 102 event is converted to a neutral format. In the preferred embodiment, the cross-platform encompasses Windows™, Java™ and HTML GUI. At step 814, IQ-Connect filters the neutrally formatted child GUI 102 event and matches it to an IQ-Event that the IQ-GUI 304 can react to. The IQ-Connect filter finds the correct IQ-Event for any IQ-Connect detected child GUI event/transition. At step 816 IQ-Connect populates any additional business objects that the IQ-Event requires. IQ-Connect “screen scrapes” the child GUI 102 at the time of the child GUI event. As an example, “screen scraping” the child GUI 102 can be extracting data from the child GUI 102. The text data visible on the screen at the time of the event is used to populate business objects that the IQ-Event may require. At step 818 IQ-Connect fires the IQ-Event. The IQ-GUI 304 listens for any IQ-Events fired by IQ-Connect and at step 820 the IQ-GUI 304 detects the IQ-Event. The IQ-GUI 304 detects an IQ-Event and formats the IQ-GUI display 304 based on the information contained within the IQ-Event. The application GUI 802, 804 or 806 will be automatically re-sized and positioned to fit within the IQ-GUI 304. After step 820, or if no match is found at step 814, IQ-Connect wait for the next GUI event.

IQ-Connect requires some initial information about the child GUI 102 to be wrapped and responded to. This information typically takes the forms illustrated in Table 1 for various applications.

TABLE 1
Child GUI Application Properties Required

Native Windows GUI application:
The GUI application executable file - typically the EXE file used to
run the application.
The IEventMonitor class used by IQ-Connect to hook into the native
windows event queue, to detect, translate, populate and fire IQ-Events.
Java GUI application:
The classpath of the Java application - typically a list of directories
and/or jar files.
The start class of the GUI application (the class which has
the main method).
The IEventMonitor class used by IQ-Connect to hook into
the Java AWT event
queue, to detect, translate, populate and fire IQ-Events.
HTML application:
The start URL for the HTML application.
The IEventMonitor class used by IQ-Connect to hook into the
browser navigation
system, to detect, translate, populate and fire IQ-Events.

When IQ-Connect is started, it invokes and launches the child GUI application 102 to which the IQ-GUI 304 is to wrap around and react to. IQ-Connect then invokes an IEventMonitor instance for the child GUI application 102. It is this class that hooks dynamically into the child GUI application 102. It listens for particular events/transitions from the child GUI 102. Once a child GUI event or transition is detected by the IEventMonitor it translates this event/transition into a platform independent neutral message. In the preferred embodiment, the format of the neutral platform independent message is as illustrated in Table 2.

TABLE 2

| Type | Description | Examples |
|---|---|---|
| id | The type of the GUI event or transition. | java.awt.event.WindowEvent. |
| | | WINDOW_OPENED |
| | | java.awt.event.MouseEvent. |
| | | MOUSE_PRESSED |
| | | com.econiq.html.HTMLEvent. |
| | | HTML_LOAD |
| source | The source object of the GUI | javax.swing.JButton |
| | event or transition. | com.econiq.html.HTMLSource |
| sourceText | The text (if any visible) on the | Ok, Cancel, Exit |
| | source object that generated the | |
| | GUI event or transition. | |
| keyCode | If the GUI event type is a | Typical keyCodes IQ-Connect |
| | keyboard related event then | would respond to would be the |
| | capture the key codes used in | keyCodes for the Enter, tab, and |
| | generating the event. | Space-bar keys etc. |
| keyModifiers | If the GUI event type is a | If the Alt, Ctrl and Shift keys were |
| | keyboard related event then | held during the event. |
| | capture any key modifiers that | |
| | were used in generating the event. | |
| contentText | Screen scrape the screen which | The following text would have |
| | generated the GUI event. | being screen scraped from the GUI |
| | | screen shown in FIG. 1: |
| | | [Customer/Account Maintenance |
| | | System, User logon, , Username:, , |
| | | Password:, , Logon] |

IQ-Connect compares this message to a registry of known GUI events. In one embodiment, IQ-Connect uses an XML file to hold the registry of known GUI events to IQ-Events. However, it would be possible to store this registry as a different file or database format. The XML event registry follows a DTD format. Other elements and attributes may be added to the DTD later.

Below is an illustrative type of registry, in XML format. The IEventMonitor compares the incoming GUI event/transition with this registry to determine if that particular GUI event/transition maps to an actual IQ-Event.

```
<?xml version=“1.0” encoding=“UTF-8”?>
<events>
  <mask id=“java.awt.AWTEvent.WINDOW_EVENT_MASK” />
  <mask id=“java.awt.AWTEvent.MOUSE_EVENT_MASK” />
  <mask id=“java.awt.AWTEvent.COMPONENT_EVENT_MASK” />
  <event id=“java.awt.event.WindowEvent.WINDOW_OPENED”
source=“javax.swing.JFrame” sourceText=“ACME Customer / Account Maintenance
System” masks=“WINDOW_EVENT_MASK” mapsTo=“CAMS_START”
useUser=“false” useRole=“false” useCustomer=“false”>
    <complete_content text=“[ACME Customer / Account Maintenance System, User
logon, , Username:, , Password:, , Logon]” />
    <screen_content>
      <content_item position=“0” type=“string” pattern=“ACME Customer / Account
Maintenance System” />
    </screen_content>
  </event>
  <event id=“java.awt.event.MouseEvent.MOUSE_PRESSED”
source=“com.econiq.cams.gui.swing.IQButton” sourceText=“Logon”
masks=“MOUSE_EVENT_MASK” mapsTo=“CAMS_LOGON_REQUEST”
useUser=“true” useRole=“true” useCustomer=“true”>
    <complete_content text=“[ACME Customer / Account Maintenance System, User
logon, , Username:, myoung, Password:, pass1, Logon]” />
    <screen_content>
      <content_item position=“0” type=“string” pattern=“ACME Customer / Account
Maintenance System” />
      <content_item position=“1” type=“string” pattern=“User logon” />
      <screen_object name=“User” classname=“com.econiq.iq.engine.bo.User”>
        <parameter name=“username” type=“java.lang.String” position=“4” index=“0” />
        <parameter name=“password” type=“java.lang.String” position=“6” index=“0” />
      </screen_object>
    </screen_content>
  </event>
  <event id=“java.awt.event.ComponentEvent.COMPONENT_SHOWN”
source=“com.econiq.cams.gui.customersearch.CustomerSearchPanel”
masks=“COMPONENT_EVENT_MASK” mapsTo=“CUSTOMER_SEARCH”
useUser=“true” useRole=“true” useCustomer=“true”>
    <complete_content text=“[ACME Customer / Account Maintenance System,
Customer Search Criteria, By name, First name, , Last name, , By account, Account,
, By SSN#, Number, , Previous sessions:, null, Go, Clear, Search, Customer Search
Results, [[First name, Middle name, Last name, Date of Birth, SSN #, Address]],
Selected Customer's Accounts, [[Account Number, Account Type, Account Title,
Balance]], Problem Resolution, Service, Sale, Exit]” />
    <screen_content>
      <content_item position=“0” type=“string” pattern=“ACME Customer / Account
Maintenance System” />
      <content_item position=“1” type=“string” pattern=“Customer Search Criteria” />
    </screen_content>
  </event>
</events>
```

The illustrative type of registry in XML format depicted above follows the DTD format illustrated below.

```
<?xml version=“1.0” encoding=“UTF-8”?>
<!ELEMENT events (mask+, event+)>
<!ELEMENT mask EMPTY>
<!ATTLIST mask
    id CDATA #REQUIRED
>
<!ELEMENT event (complete_content*, screen_content, result*)>
<!ATTLIST event
    id CDATA #REQUIRED
    source CDATA #REQUIRED
    sourceText CDATA #IMPLIED
    masks CDATA #REQUIRED
    keyCode CDATA #IMPLIED
    keyModifiers CDATA #IMPLIED
    mapsTo CDATA #REQUIRED
>
<!ELEMENT result (screen_content)>
<!ATTLIST result
    mapsTo CDATA #REQUIRED
>
<!ELEMENT screen_content (content_item+, screen_object*)>
<!ELEMENT complete_content EMPTY>
<!ATTLIST complete_content
    text CDATA #REQUIRED
>
<!ELEMENT content_item EMPTY>
<!ATTLIST content_item
    position CDATA #REQUIRED
    type CDATA #REQUIRED
    pattern CDATA #REQUIRED
>
<!ELEMENT screen_object (parameter*)>
<!ATTLIST screen_object
    name CDATA #REQUIRED
    classname CDATA #REQUIRED
    reset CDATA #IMPLIED
    position CDATA #IMPLIED
    type CDATA #IMPLIED
>
<!ELEMENT parameter EMPTY>
<!ATTLIST parameter
    name CDATA #REQUIRED
    type CDATA #REQUIRED
    position CDATA #REQUIRED
    index CDATA #REQUIRED
    formatter CDATA #IMPLIED
```

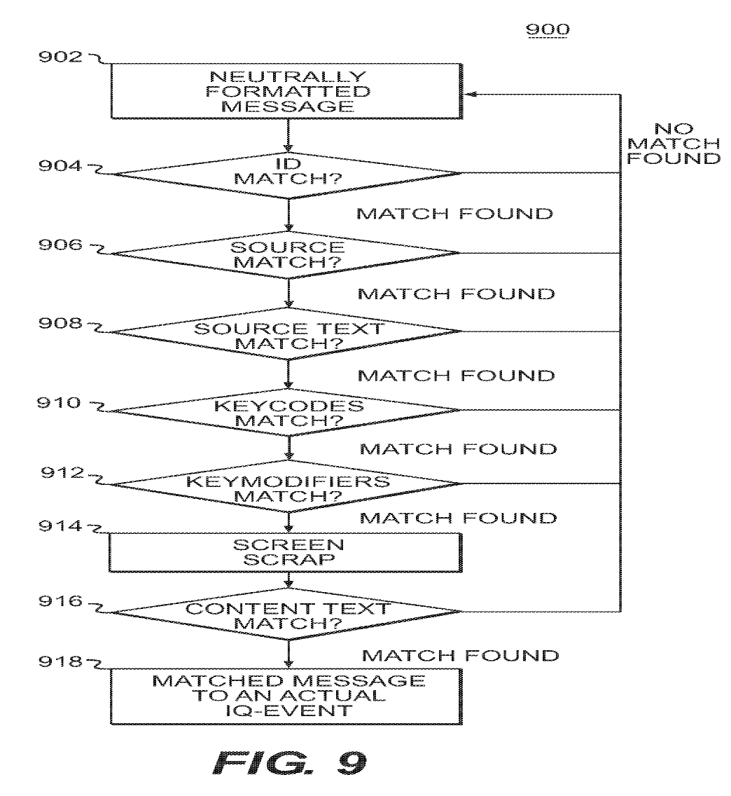

Reference is now made to FIG. 9 where the logical flow 900 for making a decision as to whether a GUI event matches a known IQ-Event is depicted. The logical flow 900 starts at step 902 where the neutrally formatted message is created. Then, the IQ-Connect compares the id at step 904, the source at step 906, the sourceText at step 908, the keyCode at step 910 and the keyModifiers at step 912 to the registry of known GUI events. If it finds an initial match based on these settings, it then screen scrapes the GUI application 102 at step 914 to pull all the visible text from the current GUI display. When the text is pulled from the GUI 102, the position in which the text was pulled from the screen is maintained in a linked positional list. In an embodiment, the position is not the visual X and Y coordinate position of the actual text but rather the order in which the particular text was pulled during the screen scrape. For example, the text in FIG. 1 when screen scraped would have pulled the text from the screen and in the particular order illustrated in Table 3.

TABLE 3

| Position | Text |
|---|---|
| 0 | Customer/Account Maintenance System |
| 1 | User logon |
| 2 | |
| 3 | Username: |
| 4 | |
| 5 | Password: |
| 6 | |
| 7 | Logon |

Referring back to FIG. 9, the registry indicates the text that must be pulled from the screen if IQ-Connect is to correctly match the GUI event to an IQ-Event at step 918. Having matched the GUI event to an initial IQ-Event, the screen scraped text data is used to verify that the match is correct at step 916. If no match is found at one of the steps 904, 906, 908, 910, 912, 914 and 916, then IQ-Event restarts at step 902. Determining an event based on just the id, source, sourceText, keycode and keyModifiers of the GUI event may not be enough, for example, the “Ok” button may appear on more than one screen. A GUI event from this button would have the same id, source and sourceText as every other “Ok” button in the GUI, so the final verification using the screen scraped text is required to ensure that the system is reacting to the correct event. For example, the XML registry defined the following for the “LOGON_REQUEST” IQ-Event:

```
<event id=“java.awt.event.MouseEvent.MOUSE_PRESSED”
        source=“com.econiq.cams.gui.swing.IQButton”
        sourceText=“Logon”
        mapsTo=“LOGON_REQUEST”
  <screen_content>
    <content_item position=“0” type=“string” pattern=“Customer /
    Account Maintenance System” />
    <content_item position=“1” type=“string” pattern=“User logon” />
  </screen_content>
</event>
```

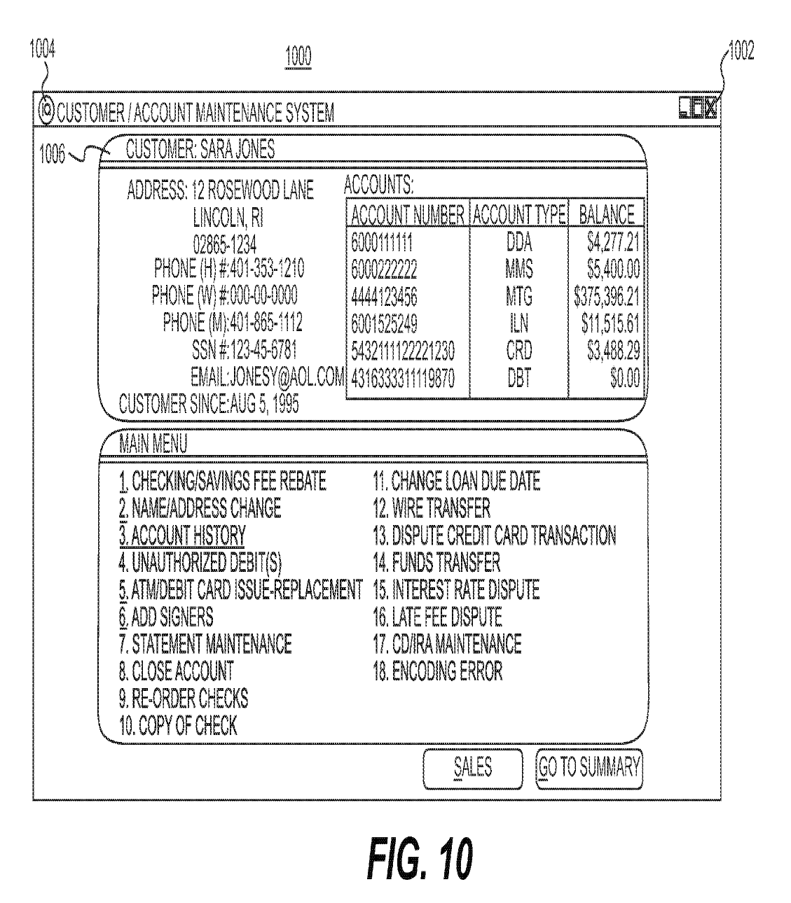

The registry indicates that the following text: “Customer/Account Maintenance System” in position 0, and “User logon” in position 1 must be contained in the screen scrape for there to be a match of the MOUSE_PRESSED on the “Logon” button to the “LOGON_REQUEST” IQ-Event. The pattern attribute is a regular expression and as such uses pattern matches to determine if the text is the same as that on the GUI screen. For example, when the screen 1002 of FIG. 10 is screen scraped, element 0 of the screen scrape is element 1004 and element 1 of the screen scrape is the following element 1006:

### Customer: Sara Jones

To match on this element, the system needs to modify the content_item so that any customer will be matched, therefore a regular expression is used rather than this exact text (which indicates a customer's real name):

<content_item position=“1” type=“string” pattern=“Customer: .* .*” />

Using the regular expression “Customer: .* .*” allows this content_item to be matched for every possible customer. For example, all the following examples would match on this regular expression:
Customer: Sara Jones
Customer: Joe Soap
Customer: George Wright

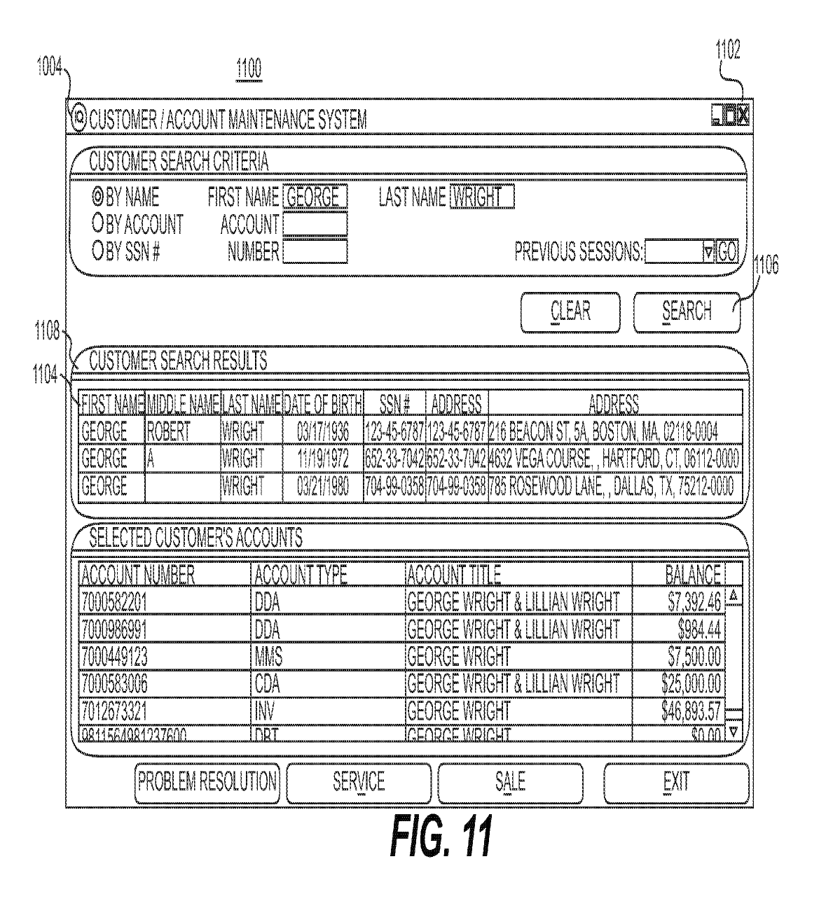

Another area where IQ-Connect uses details captured from the GUI screen is to help identify IQ-Events where tables are involved. Whenever IQ-Connect comes across a table component during screen scraping it builds a row by row collection for that table. FIG. 11 shows a screen shot 1102 with a table 1108 that displays the customers 1104 found during a customer search. When IQ-Connect screen scrapes this screen it gets converted to the following collection of text for position 19:
[[First name, Middle name, Last name, Date of Birth, SSN #, Address], [George, Robert, Wright, 03/17/1936, 123-45-6787, 216 Beacon St, 5A, Boston, Mass., 02118-0004], [George, A, Wright, 11/19/1972, 652-33-7042, 4632 Vega Course, Hartford, Conn., 06112-0000], [George, Wright, 03/21/1980, 704-99-0358, 785 Rosewood Lane, Dallas, Tex., 75212-0000]]

The registry allows to indicate if a fixed size table or variable sized table is being looked for. The following XML registry allows the determination of whether a “NO_CUSTOMER_FOUND” IQ-Event or “SELECT_CUSTOMER” IQ-Event would occur based on the table data scraped from the GUI screen:

```
<event id=“java.awt.event.MouseEvent.MOUSE_CLICKED”
          source=“com.econiq.cams.gui.swing.IQButton”
          sourceText=“Search”
          mapsTo=“SEARCH”>
  <screen_content>
    <content_item position=“0” type=“string” pattern=“Customer /
    Account Maintenance System” />
    <content_item position=“1” type=“string” pattern=“Customer
    Search Criteria” />
  </screen_content>
  <result mapsTo=“NO_CUSTOMER_FOUND”>
      <screen_content>
        <content_item position=“19” type=“table” pattern=“=1” />
    </result>
  <result mapsTo=“SELECT_CUSTOMER”>
    <screen_content>
      <content_item position=“19” type=“table” pattern=“>1” />
    </screen_content>
  </result>
</event>
```

This example indicates that if the “Search” button 1106 is clicked with the mouse and the text “Customer/Account Maintenance System” 1004 and “Customer Search Criteria” is found in positions 0 and 1 of the screen scrape then an initial match of the “SEARCH” event is obtained. However, the presence of the result elements in the XML indicates to IQ-Connect that a further match must be done to determine the real IQ-Event to fire. In this example, the XML states that if position 19 is a table and its size is equal to one (i.e. only the table header is visible), then the “NO_CUSTOMER_FOUND” IQ-Event can be triggered. If the table's size was greater than one, then customers were found by the search and the “SELECT_CUSTOMER” IQ-Event can be triggered.

Once a GUI event is matched to an actual IQ-Event, the IQ-Event is then populated with any IQ business objects that might be required by the IQ-GUI 304 to interact correctly with the wrapped application GUI. IQ-Connect uses four main objects: User, Role, Customer and Data. However, additional objects may be added later. IQ-Connect can populate these objects automatically based on the text screen scraped from the GUI application. The following example indicates how, based on the XML registry of GUI events to IQ-Events, IQ-Connect would populate the user object whenever a “LOGON_REQUEST” IQ-Event occurs:

```
<event id=“java.awt.event.MouseEvent.MOUSE_PRESSED”
        source=“com.econiq.cams.gui.swing.IQButton”
        sourceText=“Logon”
        mapsTo=“LOGON_REQUEST”>
  <screen_content>
    <content_item10 position=“0” type=“string” pattern=“Customer /
    Account Maintenance System” />
    <content_item position=“1” type=“string” pattern=“User logon” />
    <screen_object name=“User”
    classname=“com.econiq.iq.engine.bo.User”>
    <parameter name=“username” type=“java.lang.String” position=“4”
index=“0” />
      <parameter name=“password” type=“java.lang.String”
      position=“6”index=“0” />
    </screen_object>
  </screen_content>
</event>
```

The screen_object User is populated based on the text scraped from the GUI application 102. The User.username is mapped to position 4 in the text scraped from the GUI application 102, while the User.password is mapped to position 5 in the text scraped from the GUI application 102. The user object can then be passed with the IQ-Event when IQ-Connect fires the IQ-Event. The IQ-GUI 304 is designed to detect IQ-Events fired to it. Once the IQ-GUI 304 detects that an IQ-Event has been fired, it displays whatever additional functionality it has been designed to display around the child GUI application 102. The IQ-GUI 304 is not only displaying additional functionality but it is also context sensitive to the position and data the child GUI application 102 is displaying. This is possible because the IQ-Event itself contains business objects that are directly populated from the GUI application 102 when the GUI application 102 fired its GUI event or transition.

As depicted above, the invention allows to not alter the original source code of the child GUI 102. IQ-Connect dynamically invokes the child GUI 102 by using the child GUI application properties as outlined earlier in Table 1. When IQ-Connect invokes or launches the child GUI 102, the IEventMonitor class for the child GUI 102 dynamically adds itself to one or more of the freely accessible event or transition systems available to it by the child GUI 102 or by the underlying platform on which the child GUI 102 was built. IQ-Connect discretely monitors the child GUI's accessible events or transitions and using the technique already outlined it can make the parent GUI 304 react and respond to the child GUI 102 as if the two applications were linked, but where no real or physical connection actually exists between the applications.

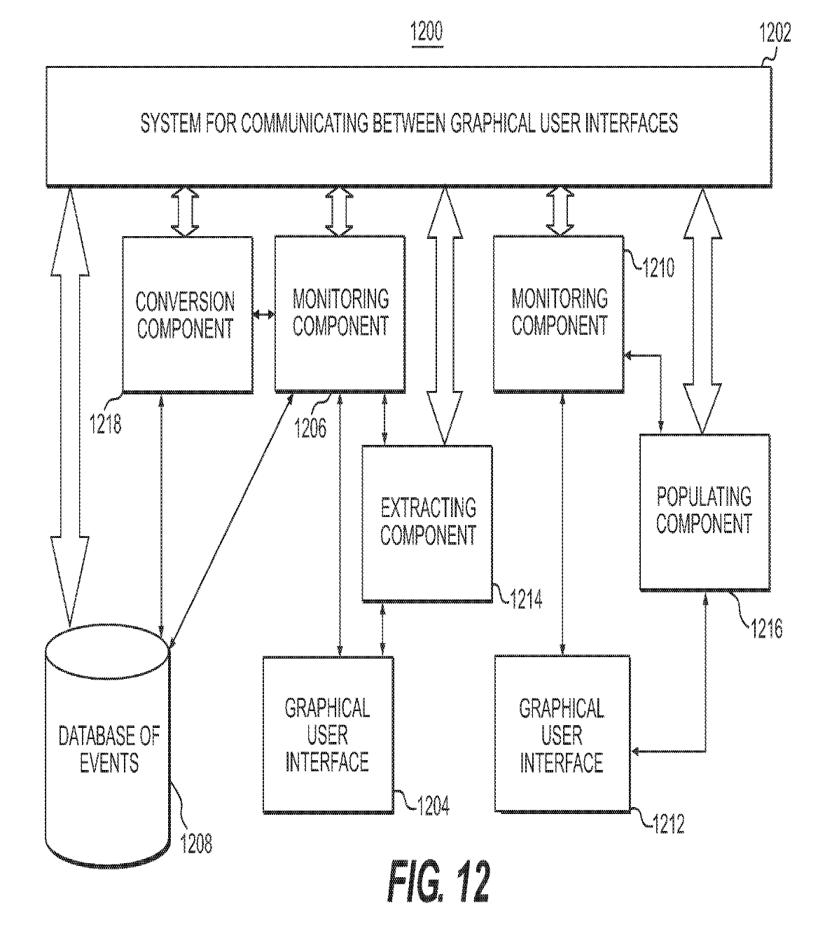

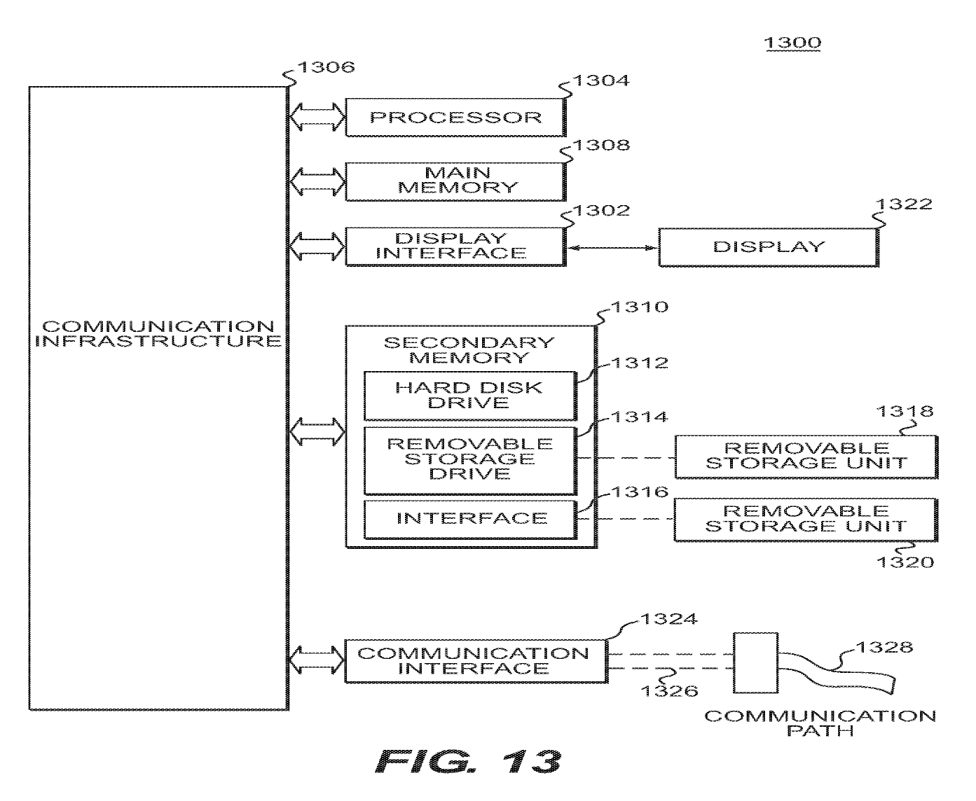

Reference is now made to FIG. 12, where a system for communicating between graphical user interfaces 1202 is depicted. The system for communicating between graphical user interfaces 1202 comprises a monitoring component 1206 monitoring events of a graphical user interface 1204; a database of events 1208, the monitoring component 1206 querying the database of events to determine if a monitored event of the graphical user interface 1204 matches one of the events stored in the database of events 1208; and a monitoring component 1210 detecting that an update of a graphical user interface 1212 is necessary should the monitored event of the graphical user interface 1204 match one of the events stored in the database of events 1208. Furthermore, the system 1202 comprises an extracting component 1214 extracting data from the graphical user interface 1204 and a populating component 1216 populating the graphical user interface 1212 with at least a portion of the data extracted from the graphical user interface 1204 should the monitored event of the graphical user interface 1204 match one of the events stored in the database of events 1208. Additionally, the system 1202 comprises a conversion component 1218 converting the monitored events of the graphical user interface 1204 in a markup language.

The method 800 of FIG. 8 used by the system 1202 in converting an event of the graphical user interface 1204 to make the graphical user interface 1212 respond can be implemented by using hardware, software or a combination thereof and may be implemented in one or more computer systems or other processing systems. An example of a computer system 1300 is shown in FIG. 13. The computer system 1300 includes one or more processors, such as processor 1304. Processor 1304 can support various operating system such as Windows®, Unix®, Linux®, Mac OS®, or the like. The processor 1304 is connected to a communication infrastructure 1306 (e.g., a communications bus, cross-over bar, or network). Various software embodiments are described in terms of this exemplary computer system. After reading this description, it will become apparent to a person skilled in the relevant art(s) how to implement the invention using other computer systems and/or computer architectures.

Computer system 1300 can include a display interface 1302 that forwards graphics, text, and other data from the communication infrastructure 1306 (or from a frame buffer not shown) for display on the display device 1322.

Computer system 1300 also includes a main memory 1308, preferably random access memory (RAM), and can also include a secondary memory 13 10. The secondary memory 1310 can include, for example, a hard disk drive 1312 and/or a removable storage drive 1314, representing a floppy disk drive, a magnetic tape drive, an optical disk drive, or the like. The removable storage drive 1314 reads from and/or writes to a removable storage unit 1318 in a well known manner. Removable storage unit 1318, represents a floppy disk, magnetic tape, optical disk, of the like, which is read by and written to by removable storage drive 1314. As will be appreciated, the removable storage unit 1318 includes a computer usable storage medium having stored therein computer software and/or data.

In alternative embodiments, secondary memory 1310 can include other similar devices for allowing computer programs or other instructions to be loaded into computer system 1300. Such devices can include, for example, a removable storage unit 1320 and an interface 1316. Examples of such can include a program cartridge and cartridge interface (such as that found in video game devices), a removable memory chip (such as an EPROM, or PROM) and associated socket, and other removable storage units 1320 and interfaces 1316 which allow software and data to be transferred from the removable storage unit 1320 to computer system 1300.

Computer system 1300 can also include a communication interface 1324. Communications interface 1324 allows software and data to be transferred between computer system 1300 and external devices. Examples of communications interface 1324 can include a modem, a network interface (such as an Ethernet card), a communications port, a PCMCIA slot and card, infrared, radio frequency (RF), or the like. Software and data transferred via communications interface 1324 are in the form of signals 1326 which can be electronic, electromagnetic, optical or other signals capable of being received by communications interface 1324. These signals 1326 are provided to communications interface 1324 via a communications path (i.e., channel) 1328. This channel 1328 carries signals 1326 and can be implemented using wire or cable, fiber optics, a phone line, a cellular phone link, an RF link and other communications channels.

In this document, the terms “machine readable program storage medium, embodying a program of instructions executable by a machine”, “computer program medium” and “computer usable medium” are used to generally refer to media such as removable storage drive 1314, a hard disk installed in hard disk drive 1312, and signals 1326. These computer program products are devices for providing software to computer system 1300. Computer programs (also called computer control logic) are stored in main memory 1308 and/or secondary memory 1310. Computer programs can also be received via communications interface 1324. Such computer programs, when executed, enable the computer system 1300 to perform the features of the present invention as discussed herein. In particular, the computer programs, when executed, enable the processor 1304 to perform the features of the present invention. Accordingly, such computer programs represent controllers or modules of the computer system 1300.

In an embodiment, software can be stored in a computer program product and loaded into computer system 1300 using removable storage drive 1314, hard drive 1312, interface 1316 or communications interface 1324. The control logic or modules (software), when executed by the processor 1304, causes the processor 1304 to perform the functions described herein. In another embodiment, the implementation uses hardware, for example, hardware components such as application specific integrated circuits (ASICs). Implementation of the hardware state machine so as to perform the functions described herein will be apparent to persons skilled in the relevant art(s). In yet another embodiment, the implementation uses a combination of both hardware and software.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A method of communicating between a first graphical user interface and a second graphical user interface comprising:
monitoring events of the first graphical user interface;
querying a database of events by comparing a monitored event of the first graphical user interface with events stored in the database of events; and
updating the second graphical user interface should the monitored event of the first graphical user interface match one of the events stored in the database of events.

2. The method of claim 1, further comprising:
extracting data from the first graphical user interface; and
populating the second graphical user interface with at least a portion of the data extracted from the first graphical user interface should the monitored event of the first graphical user interface match one of the events stored in the database of events.

3. The method of claim 2, wherein the database of events indicates data to be extracted from the first graphical user interface should the monitored event of the first graphical user interface match one of the events stored in the database of events.

4. The method of claim 2, wherein the data is text.

5. The method of claim 4, wherein extracting text from the first graphical user interface comprises maintaining a position from which the text is extracted in a linked positional list.

6. The method of claim 5, wherein populating the second graphical user interface comprises using the linked positional list.

7. The method of claim 4, further comprising using the text extracted from the first graphical user interface to verify if a match between the monitored event of the first graphical user interface and the one of the events stored in the database of events is correct.

8. The method of claim 7, further comprising pattern matching the extracted text from the first graphical user interface.

9. The method of claim 1, further comprising converting the monitored events of the first graphical user interface in a markup language.

10. The method of claim 1, wherein the second graphical user interface is at least partially wrapped around the first graphical user interface.

11. The method of claim 1, further comprising:
monitoring events of a third graphical user interface;
querying a database of events by comparing a monitored event of the third graphical user interface with events stored in the database of events; and
updating the second graphical user interface should the monitored event of the third graphical user interface match one of the events stored in the database of events.

12. A system for communicating between a first graphical user interface and a second graphical user interface comprising:
a first monitoring component monitoring events of the first graphical user interface;
a database of events, the first monitoring component querying the database of events to determine if a monitored event of the first graphical user interface matches one of the events stored in the database of events; and
a second monitoring component detecting that an update of the second graphical user interface is necessary should the monitored event of the first graphical user interface match one of the events stored in the database of events.

13. The system of claim 12, further comprising an extracting component extracting data from the first graphical user interface.

14. The system of claim 13, further comprising a populating component populating the second graphical user interface with at least a portion of the data extracted from the first graphical user interface should the monitored event of the first graphical user interface match one of the events stored in the database of events.

15. The system of claim 13, wherein the database of events indicates data to be extracted from the first graphical user interface should the monitored event of the first graphical user interface match one of the events stored in the database of events.

16. The system of claim 12, further comprising a conversion component converting the monitored events of the first graphical user interface in a markup language.

17. The system of claim 12, wherein the data is text.

18. The system of claim 17, wherein the extracting component maintains a position from which the text is extracted in a linked positional list.

19. The system of claim 18, wherein the populating component uses the linked positional list to populate the second graphical user interface.

20. A machine readable program storage medium, embodying a program of instructions executable by a machine to perform a method of communicating between a first graphical user interface and a second graphical user interface comprising:
monitoring events of the first graphical user interface;
querying a database of events by comparing a monitored event of the first graphical user interface with events stored in the database of events; and
updating the second graphical user interface should the monitored event of the first graphical user interface match one of the events stored in the database of events.

21. The machine readable program storage medium of claim 20, the method further comprising:
extracting data from the first graphical user interface; and
populating the second graphical user interface with at least a portion of the data extracted from the first graphical user interface should the monitored event of the first graphical user interface match one of the events stored in the database of events.
